(19) United States
(12) Patent Application Publication
(10) Pub. No.: US 2014/0266103 A1
(43) Pub. Date: Sep. 18, 2014

(54) DIGITALLY ASSISTED REGULATION FOR AN INTEGRATED CAPLESS LOW-DROPOUT (LDO) VOLTAGE REGULATOR

(71) Applicant: QUALCOMM INCORPORATED, San Diego, CA (US)

(72) Inventors: Yuhe Wang, San Diego, CA (US); Marzio Pedrali-Noy, San Diego, CA (US); Xuhao Huang, San Diego, CA (US); Martin Saint-Laurent, San Diego, CA (US); Xufeng Chen, San Diego, CA (US)

(73) Assignee: QUALCOMM INCORPORATED, San Diego, CA (US)

(21) Appl. No.: 13/843,121

(22) Filed: Mar. 15, 2013

(51) Int. Cl. G05F 1/46

(52) U.S. Cl. CPC G05F 1/462
USPC 323/274; 323/275

(57) ABSTRACT

Techniques are described that embed a digital assisted regulator with an LDO regulator on a chip without requiring a capacitor external to the chip and to regulate a voltage without undershoot. The digital assisted regulator responds to information regarding operation of the LDO regulator and to a signal that provides advance notification of a load change. When the advance notification signal is received, the digital assisted regulator pulls a circuit's supply voltage up to a chip's incoming supply voltage. When the correct operating voltage has been reached and any undershoot problem removed, the digital assisted regulator balances the current it provides with the current provided by the LDO regulator, to allow a quick response time for other load changes. Also, bandwidth of an LDO regulator may be expanded by use of an advance notice signal to increase bias current of an LDO output device to meet an upcoming load change.

### FIELD OF THE DISCLOSURE

Embodiments of the present invention relate generally to aspects of voltage regulation, and more specifically to digitally assisted regulation for an integrated capless low-dropout (LCO) voltage regulator.

### BACKGROUND

Many portable products, such as cell phones, laptop computers, personal data assistants (PDAs) and the like, utilize a processing system that executes programs, such as communication and multimedia programs. A processing system for such products may include multiple processors, complex memory systems including multi-levels of caches and memory for storing instructions and data, controllers, peripheral devices such as communication interfaces, and fixed function logic blocks configured, for example, on a single chip. At the same time, portable products have a limited energy source in the form of batteries that are often required to support high performance operations by the processing system and increasingly large memory capacities as functionality increases. Such concerns extend to personal computer products which are also being developed with efficient designs to operate with reduced overall energy consumption.

In such portable systems, one or more low-dropout (LDO) voltage regulators, also referred to as LDO regulators, are generally embedded on a power management chip to regulate one or more voltages for circuits on one or more chips. Each LDO regulator of the multiple LDO regulators is used to regulate a voltage for circuits in a specific power domain. Also, each power domain may experience a wide range of loads that vary over a wide range of frequencies. For example, in a portable cell phone device having integrated functions, such as video capture, modem functions, and a user interface, the processor's clock frequencies are adjusted to the task at hand to optimize power usage. Since tasks vary according to phone usage, the loads an LDO regulator must respond to are always changing and may change at a high frequency depending on program use of various on-chip functions.

A particular problem associated with changing loads, for example on bringing up a circuit, such as a digital signal processor circuit, from a sleep state, is voltage undershoot, where a supply voltage to the circuit drops below an operating voltage level. If the voltage drop is large enough, the circuit may experience incorrect operation, for example by changing an existing state of operation. One approach to addressing this problem has been to use a large external capacitor on an LDO regulator's output to stabilize its voltage. As a consequence, embedding an LDO regulator in a power domain with a target circuit requires an external pin for the large external capacitor. Also, for efficient operation of the LDO regulator, the external pin is required to be of low inductance, a difficult package and design requirement. A large inductance will impede the current flow and cause voltage undershoot that may render the system to be not functional. Since impedance equals inductance (L)*dl/dt, the rate of change of the current, a large impedance limits the current flowing onto chip from an external cap. Once charge from on chip caps are depleted to the extent that it is not filled and the load current is not supplied either by an LDO regulator due to limited bandwidth or by the external cap due to large lead inductance, the processor supply drops below a required level which could cause circuit timing errors and thus functional errors.

For example, FIG. 1 illustrates a prior art low dropout (LDO) regulator subsystem 100. The LDO regulator subsystem 100 includes an LDO regulator 104 embedded in a system chip 102 having circuitry with a load current (I_{load}) 106. The voltage output of the LDO regulator Vload 108 is brought to a package pin 110 of the system chip package having a package pin inductance 112 which is generally in the range of 2 nano Henrys (nH) to 20 nH, but preferably should be designed to be less than 0.3 nH. The package pin 110 is connected to an external capacitor (Cₑₓₜ) 114. Depending on load current (I_{load}) 106 the Cₑₓₜ 114 generally is in the range of 2 micro Farads (μF) to 20 μF. Thus a chip with multiple power domains with embedded LDO regulators would require multiple pins, each pin, such as package pin 110, having low inductance preferably less than 0.3 nH, and board real estate for multiple capacitors, each for example in the range of 2 μF to 20 μF.

### SUMMARY

Among its several aspects, the present disclosure recognizes that it is desirable to provide more efficient methods and apparatuses for embedded voltage regulation to reduce or remove undershoot voltage problems that occur on load changes. To such ends, an embodiment of the invention addresses a method for low-dropout regulation. A digital to analog converter (DAC) is enabled in response to an advance notification signal supplied by a system circuit, wherein the advance notification signal indicates a change in load requiring increased current is to begin in a predetermined period. A current provided by the DAC is combined with a current provided by a low-dropout (LDO) regulator to supply the system circuit, wherein voltage undershoot to the system circuit is reduced or removed as addressed further below.

Another embodiment addresses an apparatus for low-dropout regulation. A low-dropout (LDO) regulator is configured to provide linear regulation of voltage and current. A digital assisted regulator is coupled to the LDO regulator and configured to provide digital assisted regulation of voltage and current. A system circuit is coupled to the digital assisted regulator and to the LDO regulator to receive supply voltage and current. The system circuit has an advance notification circuit that is configured to notify the digital assisted regulator of an impending load change in time for the digital assisted regulator to supply current to the system circuit required by the load change.

Another embodiment addresses an apparatus for system assisted low-dropout regulation. A system circuit having an advance notification circuit is configured to generate an advance notification signal that a load change is to occur in a predetermined time period. A low-dropout (LDO) regulator is configured for providing linear regulation of voltage and current to the system circuit, coupled to the system circuit to receive the advance notification signal and expand the bandwidth of the LDO regulator during the time of the load change in response to the advance notification signal.

Another embodiment addresses a computer readable non-transitory medium encoded with computer readable program data and code. A digital to analog converter (DAC) is enabled in response to an advance notification signal supplied by a system circuit, wherein the advance notification signal indicates a change in load requiring increased current is to begin in a predetermined period. A current provided by the DAC is combined with a current provided by a low-dropout (LDO) regulator to supply the system circuit, wherein voltage undershoot to the system circuit is reduced or removed.

Another embodiment addresses an apparatus for low-dropout regulation. Means is utilized for digital assisted regulation of a voltage and current. Means is utilized for linear regulation of a voltage and current coupled to the digital regulation means and configured to operate in conjunction with the digital regulation means. Means is utilized for providing an advance notification to the digital regulation means of an impending load change in time to supply current to the system circuit required by the load change.

A further embodiment addresses an apparatus for system assisted low-dropout regulation. Means is utilized to generate an advance notification signal that a load change is to occur in a predetermined time period. Means is utilized to receive the advance notification signal and expand the bandwidth of the LDO regulator during the time of the load change in response to the advance notification signal.

It is understood that other embodiments of the present invention will become readily apparent to those skilled in the art from the following detailed description, wherein various embodiments of the invention are shown and described by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Various aspects of the present invention are illustrated by way of example, and not by way of limitation, in the accompanying drawings, wherein:

FIG. 1 illustrates a prior art low dropout regulator subsystem;

FIG. 2 illustrates a digitally assisted LDO regulator subsystem;

FIG. 3 is a timing diagram illustrating operation of the digitally assisted LDO regulator;

FIG. 4 illustrates an exemplary system assisted LDO regulator; and

FIG. 5 illustrates a particular embodiment of a portable device that utilizes an exemplary digitally assisted LDO regulator in accordance with embodiments of the invention.

### DETAILED DESCRIPTION

The detailed description set forth below in connection with the appended drawings is intended as a description of various exemplary embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well known structures and components are shown in block diagram form in order to avoid obscuring the concepts of the present invention.

To address the problems of package pin requirements, board real estate for external large capacitors, voltage undershoot, and the like, a different approach to providing voltage regulation is utilized as shown in FIG. 2. FIG. 2 illustrates an exemplary digitally assisted LDO regulator subsystem 200 that combines a digital assisted regulator 203 with an LDO regulator 205 embedded in a system chip 202. The digitally assisted regulator 203 includes a digital controller 204, a current analog to digital converter (ADC) 206, and a transistor assembly 207 embedded with the LDO regulator 205 in the system chip 202 having a system circuit 208, such as a processor complex. Operations in the digital controller 204 are clocked by the clock 226, whose frequency is selected based on response times of the devices in the LDO regulator 205 and the transistor assembly 207, such as 20 MHz. The digital controller 204 may be operated by a finite state machine or may be operated by a processor executing a program that responds to an advance notification signal and digital LDO operating information to control a supply of current to a system circuit. The system circuit 208 is supplied with voltage V_{dd}_{_{—}}_{load} 209 generated by the combination of the digitally assisted regulator 203 and the LDO regulator 205, also abbreviated to LDO 205.

The digital controller 204 and transistor assembly 207 are configured to operate as an integrated current digital to analog controller (IDAC) and in parallel with the LDO regulator 205 and current ADC 206. For example, the transistor assembly 207 is coupled to an LDO output device 216 at the supply voltage V_{dd}_{_{—}}_{load} 209 for the system circuit 208. An advance notification signal 218 is provided by the system circuit 208, such as by a processor circuit or by a finite state machine circuit that indicates a load change is to occur within a short time frame. For example, the system circuit 208 in response to a program enabling of an on chip complex function, such as a multimedia subsystem, may cause the advance notification signal 218 to be issued prior to such enabling. A notification of a load change from 50 microAmp (uA) that rises in 20 nanoseconds (ns) to a 100 milliamps (mA) for example, may be sent 15-ns ahead of the load change. The 15-ns period is dependent on the IDAC 204/207 turn on time. A period for advance notification longer than the IDAC 204/207 turn on time is also acceptable for proper operation. The transistor assembly 207 turns on in response to the advance notification signal 218 to supply voltage and current to the system circuit 208 in parallel with the LDO output device 216. For example, when the advance notification signal 218 is received, the digital controller 204 supplies control (Ctrl) signals 228 to the transistor assembly 207 that drives the transistor assembly 207 to pull the system circuit supply voltage V_{dd}_{_{—}}_{load} 209 up toward a chip's incoming supply voltage V_{ddext} 219. The digital controller 204 takes input from current ADC 206 that indicates how much current 216 is sourcing and controls a ramp down of the V_{dd}_{_{—}}_{load} 209 voltage to a specified operating voltage of the system circuit 208, which for example, may be at a lower voltage than V_{ddext} for reasons of power control. When the correct operating voltage has been reached and any undershoot problem removed, the digital controller 204 tracks the current ADC 206 output and the advance notice signal 218 to control the amount of digitally assisted current that should be supplied. In general, the digital controller 204 and the transistor assembly 207 handles static and low frequency current requirements while the LDO 205 handles high frequency dynamic current requirements.

In another embodiment, the IDAC 204 and transistor assembly 207 balances the current it provides, according to the current ADC circuit 206, with the current provided by the LDO regulator. The IDAC 204/207 takes input from the current ADC 206 to supply the static or slow varying current which is required. The IDAC 204/207 is used to combine with the LDO 205 to extend the LDO capacity based on a predetermined current threshold that the LDO 205 supplies. The current from LDO can be divided into 3 ranges. When the current demanded is in excess of the high predetermined threshold, the current ADC 206 generates an output code 11 and the IDAC controller 204 switches more units ON in the transistor assembly 207 to reduce an amount of current being supplied from LDO 205. This process continues until the LDO current drops below the high threshold and the current ADC 206 generates an output code 01. In another operating scenario, if the LDO 205 sources current less than a lower threshold, the current ADC 206 generates an output code 00. Based on this code of 00, the IDAC controller 204 keeps turning OFF units in the transistor assembly 207 until the current ADC 206 generates an output code 01 or until all the IDAC units in the transistor assembly 207 are OFF. For static current, the range of current LDO delivers is predetermined. The IDAC 204/207 greatly extends the static current capacity to support the supply of current dissipated by on chip leakage, such as leakage in access to 300 mA for example which may occur at a fast-fast (FF) process corner and at 110 degrees Celsius. This combination provides an advanced ready state to allow a quick response time of the IDAC 204/207 to assist the LDO regulator 205 with drastic and fast dynamic load changes which may occur. Thus, the combination of a digital assisted regulator with an LDO regulator addresses the problems of package pin requirements, board real estate for external large capacitors, and voltage undershoot and extends the current delivery capacity to make the LDO stable in a much larger load current range than an analog LDO could handle alone. The LDO regulator is designed for a prespecified current capacity while the IDAC regulator current capacity can be extended without causing stability concerns.

The current ADC 206 can be configured with a single threshold comparator to supply a single bit or a plurality of threshold comparators to provide a plurality of bits depending on the granularity of control desired. As the LDO regulator current increases as determined by the I_{ref} current 222 monitored by the current ADC 206, the current ADC 206 converts the current going through LDO 205 into digital bits for the digital controller 204 to monitor. If the LDO starts to source too much current, the digital controller 204 increases the IDAC current at the transistor assembly 207, such that the LDO current falls back below or to a predetermined max value. The inverse is also true; when the LDO 205 is sourcing too little current, the IDAC current is reduced until the LDO sources more than a predetermined minimum current. If the load current from the processor load 224 is smaller than the minimum current, the transistor assembly 207 is completely turned off and all the current is supplied from the LDO 205. The LDO 205 also sources any fast transient current that may occur.

The transistor assembly 207 is a configuration of a plurality of transistors controlled in groups to increase or decrease current. For example, the transistor assembly 207 may be made up of sixty four groups of twenty five transistors in each group, such that each group of transistors is controlled by the digital controller 204 through the Ctrl signals 228. Groups of transistors are also referred to as units. The transistor assembly 207 is sized in reference to the size of the LDO pass transistor 216. The devices are matched with the same small unit in terms of gate length/width/fingers/multiplicity. The transistor unit size is chosen such that when combined with the current ADC step size and clock frequency a smooth current flow is provided. Thus, there is no contention of the analog control loop and the digital control loop. The number of transistors in each IDAC group is determined by an expected max current that the transistor assembly 207 is expected to handle. The number of transistors is generally not limited by any other factors. Only a small number of groups of the transistor assembly 207, however, is used for the undershoot control. The digital controller 204 is controlled with shift registers, for example. A small number, such as 48 IDAC units, are fully turned on when the advance notification signal 218 is received to reduce the voltage drop due to a current change. This small number is able to make a fast transition and thus shorten a time that the system takes to transition to normal regulation. The other transistors of the IDAC unit will be turned on by the digital controller 204 based on detected leakage current. Using various numbers of groups of transistors in the transistor assembly 207 allows the digital controller 204 to ramp voltages either up or down depending on the required response. In a similar manner, as the LDO regulator current decreases in response to load current, the digital controller 204 decreases the output current supplied by the transistor assembly 207 as determined by the current ADC 206. For example, with a two bit current ADC 206 comprised of two threshold comparators, an output code of “00” indicates decrease IDAC output until the output code become 01 and with an output code of “01” keep the IDAC current at present level. The IDAC output would supply a predetermined current capacity and with an output code of “11” the IDAC output would increase until the code becomes 01. Currently, an ADC 206 output code of “10” is reserved in a current implementation and will not occur.

FIG. 3 is a timing diagram 300 illustrating operation of the digitally assisted LDO regulator. The timing diagram 300 illustrates a time scale 304 divided into 25 nanosecond (ns) intervals and five signals utilized in the digitally assisted LDO regulator subsystem 200 of FIG. 2. These signals include the clock 226 used to clock operations in the digital controller 204, the load current (Iload) 224, the advance notification signal 218, the regulated output voltage Vdd_load 209, and the control (Ctrl) signals 228 for the transistor assembly 207. At the beginning reference point of time 0.0 the clock 226, shown as a 20 MHz clock, is running, the load current 224 is at a 50 microampere (μA) level and voltage Vdd_load 209 to the system circuit 208 is at a low level of 0.5 volts (V) to support a sleep mode and minimum circuit operation such as circuitry to generate the advance notice signal 218. The LDO regulator 205 is driving the Vdd_load 209. At time zero, the advance notice signal 218 and the transistor assembly Ctrl signal 228 are both off. The transistor assembly Ctrl signal 228 is a plurality of control signals represented by a digital code value, such as represented by a hex or binary number. The digital code value indicates how many IDAC units in the transistor assembly 207 are on. For example, in a fully on time period, the transistor assembly Ctrl signal 228 is set to a code to turn 48 IDAC units on. When the current requirements decrease, the digital code decreases to a different value and accordingly turning off at least one of the 48 IDAC units. The decrease continues until the current ADC 206 output code is 01, for example.

In anticipation of the system circuit turning on, at time 125 ns 306, the advance notice signal 218 is turned on. The digital controller 204 upon receiving the pre-ON advance notice signal 218, drives the transistor assembly Ctrl signals 228 to turn on the transistor assembly 207, this is highlighted by transition 308. In response to the Ctrl signals 228 turning from a completely off code during period 306 to a fully on code during period 316, the Vdd_load 209 ramps up to a full on level such as 1.0 volt in this scenario as highlighted by transition 310. The system circuit 208 turns on at a specified time period delay 312 from the generation of the advance notice signal 218, for example 50 ns later. The delay 312 would be different in different systems and is chosen such that a selected portion of the transistor assembly 207 is fully on before the load increases. The delay 312 may also have to take into account ramping the Vdd_load voltage up to the desired level. The load current Iload 224 to the system circuit 208 ramps up from the 50 μA level to 200 milliampere (mA) level in approximately 20 ns 314. Such a rapid current surge generally causes a significant voltage undershoot in prior art systems such as the LDO regulator 104 shown in FIG. 1. In the digitally assisted LDO regulator subsystem 200 of FIG. 2, the majority of this 200 mA minus 50 μA current change is supplied through the transistor assembly 207 thus preventing a voltage undershoot from occurring.

After a time delay 316, that allows any effect of the load change to be settled out, the digital controller 204 reduces the Ctrl signal 228 driving the transistor assembly 207, for example by turning a subset of groups of transistors in the transistor assembly 207 off in response to the current ADC 206. By having less transistors driving the transistor assembly 207, the Vdd_load 209 is reduced to an operating voltage level, such as 0.8 volts, required by the system circuit 208 and the voltage level is controlled by the LDO 205. The delay 318 to ramp the voltage down to operating levels is determined by the IDAC 204/207 design and load current levels according to system requirements. The advance notice signal 218 is also removed which may occur after sufficient time to ensure the digital controller 204 has received the notification of the upcoming load change. For example, the advance notification signal 218 may be an event trigger pulse that generally lasts two or three clock cycles. The system now operates in a balanced mode with part of the current supplied by the transistor assembly 207 and part by the LDO regulator 205.

FIG. 4 illustrates an exemplary system assisted LDO regulator subsystem 400 which comprises an LDO regulator 402 and a load or system circuit, such as a processor circuit 404. Bandwidth of the LDO regulator 402 is expanded by using an advance notice signal 406 to increase a bias current of the LDO regulator at the transition region. The LDO regulator 402 comprises an error amplifier corresponding to devices M1 to M8 and uses a Miller compensation capacitor Cc 408 to stabilize the LDO regulator. A variable resistor circuit Rc 410 in combination with the Cc 408 provides compensation for a particular load current required by the processor circuit 404. Once the load current varies, a pole associated with the Mpass transistor 412 varies significantly. The value of variable resistor circuit Rc 410 is made to track the change of the Mpass current so overall the LDO regulator 402 is stable for the wide range of load current, which may vary, for example from 5 uA to 200 mA.

FIG. 5 illustrates a particular embodiment of a portable device 500 that utilizes a plurality of exemplary digitally assisted LDO regulators 512₁, 512₂, . . . , 512_{N} in accordance with embodiments of the invention. FIG. 5 illustrates a portable device 500 having a dual processor core comprising a general purpose thread (GPT) processor 536 and coprocessor 538 that is configured to meet real time requirements of the portable device. The portable device 500 may be a wireless electronic device and include a system core 504 which includes a processor complex 506 coupled to a system memory 508 having software instructions 510. The portable device 500 comprises a power supply 515, an antenna 516, an input device 518, such as a keyboard, a display 520, such as a liquid crystal display LCD, one or two cameras 522 with video capability, a speaker 524 and a microphone 526. The system core 504 also includes a wireless interface 528, a display controller 530, a camera interface 532, and a codec 534. The processor complex 506 includes a dual core arrangement of the GPT processor 536 having local level 1 instruction and data caches 549 and coprocessor (CoP) 538 having a level 1 vector memory 354. The processor complex 506 may also include a modem subsystem (MSS) 540, a flash controller 544, a flash device 546, a multimedia subsystem 548, a level 2 (L2) cache tightly coupled memory (TCM) portion 550 which may be partitioned into a cache portion and a TCM portion, and a memory controller 552. The flash device 546 may suitably include a removable flash memory or may also be an embedded memory.

In an illustrative example, the GPT processor 536 and CoP 538 are configured to access data or program instructions stored in the memories of the L1 I & D caches 549, the L2 cache/TCM 550, and in the system memory 508 to provide data transactions as required for system operation.

The wireless interface 528 may be coupled to the processor complex 506 and to the wireless antenna 516 such that wireless data received via the antenna 516 and wireless interface 528 can be provided to the MSS 540 and shared with CoP 538 and with the GPT processor 536. The camera interface 532 is coupled to the processor complex 506 and is also coupled to one or more cameras, such as a camera 522 with video capability. The display controller 530 is coupled to the processor complex 506 and to the display device 520. The coder/decoder (Codec) 534 is also coupled to the processor complex 506. The speaker 524, which may comprise a pair of stereo speakers, and the microphone 526 are coupled to the Codec 534. The peripheral devices and their associated interfaces are exemplary and not limited in quantity or in capacity. For example, the input device 518 may include a universal serial bus (USB) interface or the like, a QWERTY style keyboard, an alphanumeric keyboard, and a numeric pad which may be implemented individually in a particular device or in combination in a different device.

The GPT processor 536 and CoP 538 are configured to execute software instructions 510 that are stored in a non-transitory computer-readable medium, such as the system memory 508, and that are executable to cause a computer, such as the dual core processors 536 and 538, to execute a program to provide data transactions as required by system operation. The GPT processor 536 and the CoP 538 are configured to execute the software instructions 510 and operate on data that are accessed from the different levels of cache memories, such as the L1 instruction and data caches 549, and the system memory 508.

In a particular embodiment, the system core 504 is physically organized in a system-in-package or on a system-on-chip device. In a particular embodiment, the system core 504, organized as a system-on-chip device, is physically coupled, as illustrated in FIG. 5, to the power supply 515, the wireless antenna 516, the input device 518, the display device 520, the camera or cameras 522, the speaker 524, the microphone 526, and may be coupled to a removable flash device 546. The power supply 515 is coupled to a plurality of N exemplary digitally assisted LDO regulators 512₁, 512₂, . . . , 512_{N} that each supply voltage and current to a different circuit or circuits on one or more different power domains on the system-on-chip device. Each of the digitally assisted LDO regulators 512₁, 512₂, . . . , 512_{N} corresponds to the digitally assisted LDO regulator of FIG. 2 comprising a digital controller 204, an LDO regulator 205, a current ADC 206, and a transistor assembly 207.

The portable device 500 in accordance with embodiments described herein may be incorporated in a variety of electronic devices, such as a set top box, an entertainment unit, a navigation device, a communications device, a personal digital assistant (PDA), a fixed location data unit, a mobile location data unit, a mobile phone, a cellular phone, a computer, a portable computer, tablets, a monitor, a computer monitor, a television, a tuner, a radio, a satellite radio, a music player, a digital music player, a portable music player, a video player, a digital video player, a digital video disc (DVD) player, a portable digital video player, any other device that stores or retrieves data or computer instructions, or any combination thereof.

The various illustrative logical blocks, modules, circuits, elements, or components described in connection with the embodiments disclosed herein may be implemented or performed with a general purpose processor, a digital signal processor (DSP), an application specific integrated circuit (ASIC), a field programmable gate array (FPGA) or other programmable logic components, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, for example, a combination of a DSP and a microprocessor, a plurality of microprocessors, one or more microprocessors in conjunction with a DSP core, or any other such configuration appropriate for a desired application.

The dual core processors 536 and 538 of FIG. 5 may be configured to execute instructions to allow preempting a data transaction in the multiprocessor system in order to service a real time task under control of a program. The program stored on a computer readable non-transitory storage medium either directly associated locally with processor complex 506, such as may be available through the instruction and data caches 549, or accessible through a particular input device 518 or the wireless interface 528. The input device 518 or the wireless interface 528, for example, also may access data residing in a memory device either directly associated locally with the processors, such as the processor local data caches, or accessible from the system memory 508. The methods described in connection with various embodiments disclosed herein may be embodied directly in hardware, in a software module having one or more programs executed by a processor, or in a combination of the two. A software module may reside in random access memory (RAM), dynamic random access memory (DRAM), synchronous dynamic random access memory (SDRAM), flash memory, read only memory (ROM), erasable programmable read only memory (EPROM), electrically erasable programmable read only memory (EEPROM), hard disk, a removable disk, a compact disk (CD)-ROM, a digital video disk (DVD) or any other form of non-transitory storage medium known in the art. A non-transitory storage medium may be coupled to the processor such that the processor can read information from, and write information to, the storage medium. In the alternative, the storage medium may be integral to the processor.

While the invention is disclosed in the context of illustrative embodiments for use in processor systems, it will be recognized that a wide variety of implementations may be employed by persons of ordinary skill in the art consistent with the above discussion and the claims which follow below. For example, a fixed function implementation may also utilize various embodiments of the present invention.

What is claimed is:

1. A method for low-dropout regulation, the method comprising:
enabling a digital to analog converter (DAC) in response to an advance notification signal supplied by a system circuit, wherein the advance notification signal indicates a change in load requiring increased current is to begin in a predetermined period; and
combining a current provided by the DAC with a current provided by a low-dropout (LDO) regulator to supply the system circuit, wherein voltage undershoot to the system circuit is reduced or removed.

2. The method of claim 1, wherein the current provided by the DAC is decreased until an operating voltage is reached for the system circuit.

3. The method of claim 1, wherein the current provided by the DAC is decreased to a level that balances the remaining load current supplied by the LDO to be within a predetermined range.

4. The method of claim 3, wherein the DAC and the LDO regulator are embedded within the system circuit without requiring an external package pin connection to an external capacitor.

5. The method of claim 1 further comprising:
monitoring the current provided by the LDO regulator by a current analog to digital converter to indicate whether the LDO output current is too high or too low.

6. The method of claim 1 further comprising:
Monitoring the current provided by the LDO regulator by a current analog to digital converter to indicate whether the LDO output current is too high, at a mid range operating level, or too low.

7. An apparatus for low-dropout regulation, the apparatus comprising:
a low-dropout (LDO) regulator configured to provide linear regulation of voltage and current;
a digital assisted regulator coupled to the LDO regulator and configured to provide digital assisted regulation of voltage and current; and
a system circuit coupled to the digital assisted regulator and to the LDO regulator to receive supply voltage and current and having an advance notification circuit that is configured to notify the digital assisted regulator of an impending load change in time for the digital assisted regulator to supply current to the system circuit required by the load change.

8. The apparatus of claim 7 further comprising:
a current analog to digital converter (IADC) configured to monitor current associated with the LDO regulator and provide information in digital form to the digital controller representing a level of current provided by the LDO regulator.

9. The apparatus of claim 8, wherein the IADC comprises:
a threshold comparator that monitor current associated with an LDO output device and indicates whether the LDO output current is too high or too low.

10. The apparatus of claim 8, wherein the IADC comprises:
threshold comparators that monitor current associated with the LDO output device and indicates whether the LDO output current is too high, at a mid-range operating level, or too low.

11. The apparatus of claim 7, wherein the transistor assembly comprises:
a plurality of transistors controlled by the digital controller in groups to increase or decrease current supplied to the system circuit.

12. The apparatus of claim 7, wherein the transistor assembly is driven by the digital controller to pull the supply voltage for the system circuit up toward a chip's incoming supply voltage.

13. The apparatus of claim 7, wherein the digital controller takes input from a current analog to digital controller that indicates how much current the LDO regulator is sourcing and in response controls a ramp down of the supply voltage to a specified operating voltage of the system circuit, wherein voltage undershoot to the system circuit is reduced or removed.

14. The apparatus of claim 7, wherein the digital controller and the transistor assembly handle static current requirements of the system circuit while the LDO regulator handles high frequency dynamic current requirements of the system circuit.

15. The apparatus of claim 7, the digital controller and the transistor assembly extends static current capacity of the LDO regulator to support supplying on chip leakage.

16. An apparatus for system assisted low-dropout regulation, the apparatus comprising:
a system circuit having an advance notification circuit configured to generate an advance notification signal that a load change is to occur in a predetermined time period; and
a low-dropout (LDO) regulator for providing linear regulation of voltage and current to the system circuit, coupled to the system circuit to receive the advance notification signal and expand the bandwidth of the LDO regulator during the time of the load change in response to the advance notification signal.

17. The apparatus of claim 16 further comprises:
a Miller compensation capacitor to stabilize the LDO regulator; and
a variable resistor circuit that in combination with the Miller compensation capacitor provides compensation for a particular load current required by the system circuit.

18. The apparatus of claim 17, wherein the value of the variable resistor circuit tracks the change of the load current to the system circuit, wherein the LDO regulator provides stable current supply over a wide range of current requirements.

19. A computer readable non-transitory medium encoded with computer readable program data and code, the program data and code when executed operable to:
enable a digital to analog converter (DAC) in response to an advance notification signal supplied by a system circuit, wherein the advance notification signal indicates a change in load requiring increased current is to begin in a predetermined period; and
combine a current provided by the enabled DAC with a current provided by a low-dropout (LDO) regulator to supply the system circuit, wherein voltage undershoot to the system circuit is reduced or removed.

20. An apparatus for low-dropout regulation, the apparatus comprising:
means for digital assisted regulation of a voltage and current;
means for linear regulation of a voltage and current coupled to the digital regulation means and configured to operate in conjunction with the digital regulation means; and
means for providing an advance notification to the digital regulation means of an impending load change in time to supply current to the system circuit required by the load change.

21. An apparatus for system assisted low-dropout regulation, the apparatus comprising:
means to generate an advance notification signal that a load change is to occur in a predetermined time period; and
means to receive the advance notification signal and expand the bandwidth of the LDO regulator during the time of the load change in response to the advance notification signal.
